(19) United States
(12) Patent Application Publication
(10) Pub. No.: US 2005/0106328 A1
(43) Pub. Date: May 19, 2005

(54) Method for predicting and applying painting parameters and use thereof

(76) Inventors: John R. Moore, Leonard, MI (US); Gary L. Jepsen, Washington, MI (US); Jeffrey Emmanuel Basas, Macomb, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/019,498

(22) Filed: Dec. 22, 2004

Related U.S. Application Data
(63) Continuation of application No. 10/692,768, filed on Oct. 24, 2003, now abandoned.

(51) Int. Cl. B05D 1/02; B05D 5/00

(52) U.S. Cl. 427/421.1; 427/8

(57) ABSTRACT

Methods, and uses thereof, for predicting and applying painting parameters so that predetermined painting responses are produced. In one embodiment, the method includes the steps of preparing a painting parameter-response model, predetermining painting parameters to input the model, determining painting responses based the model and inputted parameters, and applying the parameters to the paint or painting equipment. In another embodiment, the method includes the steps of preparing a painting parameter-response model, predetermining painting responses to input the model, determining painting parameters based the model and inputted responses, and applying the parameters to the paint or painting equipment.

### BACKGROUND OF THE INVENTION

This invention is directed to painting methods and more particularly to a method and use thereof for predicting and applying parameters that are suitable as input values for paint and paint application equipment to achieve desired paint responses.

Coatings scientists in the laboratories have performed complex design of experiments to study the interrelationships between paint properties and paint responses. This work generally produces mathematical models, which are typically three-dimensional depictions of the interrelationships, between paint properties and responses. These models typically interrelate multiple paint properties such as, for example, paint viscosity, film build, and gloss.

Designed experiments also can give response surface plots showing the effect of paint process input parameters such as atomizing air, fan air, paint flow rate, bell speed, or shaping air on paint response outputs such as film build and pattern width. This data very useful when a new process is set up. However, use of surface plots are cumbersome to use in an automotive or industrial plant painting environment, and also require specialized software plus a skilled user to make any reliable change of input parameters. Asuch, the plant painting environment lacks the use of design of experiments approach for determining painting parameters.

When a new industrial paint line, paint technology, or applicator technology is installed, specific painting responses from paint and painting equipment are desired, and the associated parameters such as paint flow rate, atomization air, fan air rate, bell speed, shaping air, voltage, etc. must be determined. This is also the case for existing paint lines, paint technology, or application equipment. Determining the parameters is typically performed in practice on a trial and error basis on the part of the user of painting equipment, in the plant painting environment. This is especially the case for the installation and startup of new painting equipment. While these methods are effective in creating set points, they are also time consuming and repetitive.

Furthermore, unless done in a systematic manner, the trial and error process provides no information as to how minor changes in the setpoints may effect the quality of the final paint job (i.e. there is no understanding of the working window for each input parameter nor the interaction of the various parameters). Therefore when an equipment parameter change the painting process is required, the engineer is forced to make an “educated guess”.

Thus, there is a need for methods, which predict painting parameters for paint and paint application equipment, to achieve desired paint responses that overcome the disadvantages of the prior art methods of this general type.

### SUMMARY OF THE INVENTION

The present invention claims methods, and uses thereof, for predicting and applying painting parameters so that predetermined painting responses are produced. In one embodiment, the method includes the steps of preparing a painting parameter-response model, predetermining painting parameters to input into the model, determining painting responses based the model and inputted parameters, and applying the parameters to the paint or painting equipment. In another embodiment, the method includes the steps of preparing a painting parameter-response model, predetermining painting responses to input into the model, determining painting parameters based the model and inputted responses, and applying the parameters to the paint or painting equipment.

### BRIEF DESCRIPTION OF THE DRAWINGS

The method and use of the invention will be best understood from the following description of preferred embodiments when read in connection with the accompanying drawings.

FIG. 1 is a flowchart depicting the steps for preparing a painting equipment parameter/paint response model, as well as determining and applying predicted parameters.

FIG. 2 is a diagrammatic side elevational view of a typical rotary-bell paint applicator and a spray cloud produced by it.

FIG. 3 is a two-dimensional graph representing a real paint thickness distribution as applied by a typical rotary-bell paint applicator.

FIG. 4 is a typical table of experimental runs, each run in a row, as part of a design of experiment to determine the interrelationships between paint equipment parameters and paint responses.

FIG. 5 is a representation of a computer-human input-output scheme, or GUI, for inputting/outputting painting responses and paint equipment parameters.

### DETAILED DESCRIPTION OF THE PREFERRED EMBODIMENTS

As used herein, “painting parameters” include, but are not limited to, bell speed, shaping air, fluid delivery rates, target distance, line speed, painting booth temperature, booth humidity, booth down/side-draft, circulation temperature, circulation flow rate/pressure, IR electrical settings, convection air flow convection air temperature, flash time, bake time/temperature, bake ramp (degree Fahrenheit per minute), line speed, bell cup design, equipment type/manufacturer, equipment target distance, voltage, film splits (i.e., first coat/second coat), reciprocator fluids, reciprocator tip speed, percent overlap, gun/cap/nozzle design, fluid delivery, shaping air, atomizing air, viscosity, percentage nonvolatile, application temperature, ingredient types/levels, technology/chemistry (such as waterborne or pure solvent-based chemistry), raw material supplier, supplier plant/location, production equipment type/manufacturer, manufacturing dwell time, number/amount of adjustments, shear history, processing temperature, and storage time/temperature.

The term “painting responses” are meant include, but are not limited to, gloss-horizontal, gloss-vertical, distinctness of image-horizontal (DOI-H), DOI-vertical, peel-horizontal, peel-vertical, OAR-horizontal (this response is based upon gloss, DOI, and peel responses), OAR-V, color appearance responses (such as, L, a, b color values), applied paint solids, film build, spray pattern size/diameter, percentage variation in the spray pattern, spray pattern shape (i.e. circular, oval, cigar, plateau, bimodal, peak, etc.), mathematical equations which predict spray pattern characteristics, percent overlap, transfer efficiency, pop value, sag value, pin-holing value, color Lab values, metallic brightness, metal flop, etc.

The invention is directed to a method and use thereof for predicting parameters that are suitable as input values for paint and paint application equipment to achieve desired paint responses. Statistical analysis of a properly designed response surface experiment provides algorithms capable of accurately representing and thus predicting resultant paint responses to use in the method of the invention.

In a preferred embodiment, paint responses comprise pattern size and film build from a spray gun or rotary bell applicator, based upon surface plots showing the effect of process input painting parameters such as atomizing air, fan air, paint flow rate, bell speed, shaping air. Algorithms based upon the interrelationships between these responses and parameters are particularly useful when attempting to set up and determine painting parameter start-up settings for a new paint line, paint technology, or applicator. The algorithms are also useful in adjusting existing paint and painting equipment to receive desired paint responses.

The algorithms may be used to prepare painting parameter calculation tools that can be run on any computer or device with any program capable of carrying out the algorithm calculations. For example, by using a paint applicator specific calculator, a user can input painting equipment parameters and manipulate them to achieve the desired painting responses. Further, when an application parameter requires an adjustment in the plant painting environment, the user can employ an application calculator to adjust the parameter within the applicable working window to maintain a balanced painting process.

Conversely, the algorithms may be used to prepare application calculator tools wherein painting parameters are calculated based upon desired painting responses. For example, the user may input painting responses such as spray pattern size, spray pattern shape, and film build, and the algorithm based calculator determines the pertinent painting parameters. This method gives the user the latitude to use target responses for calculating those input parameters, which achieve the responses. This embodiment may be particularly useful when day to day adjustments for existing painting equipment are necessary.

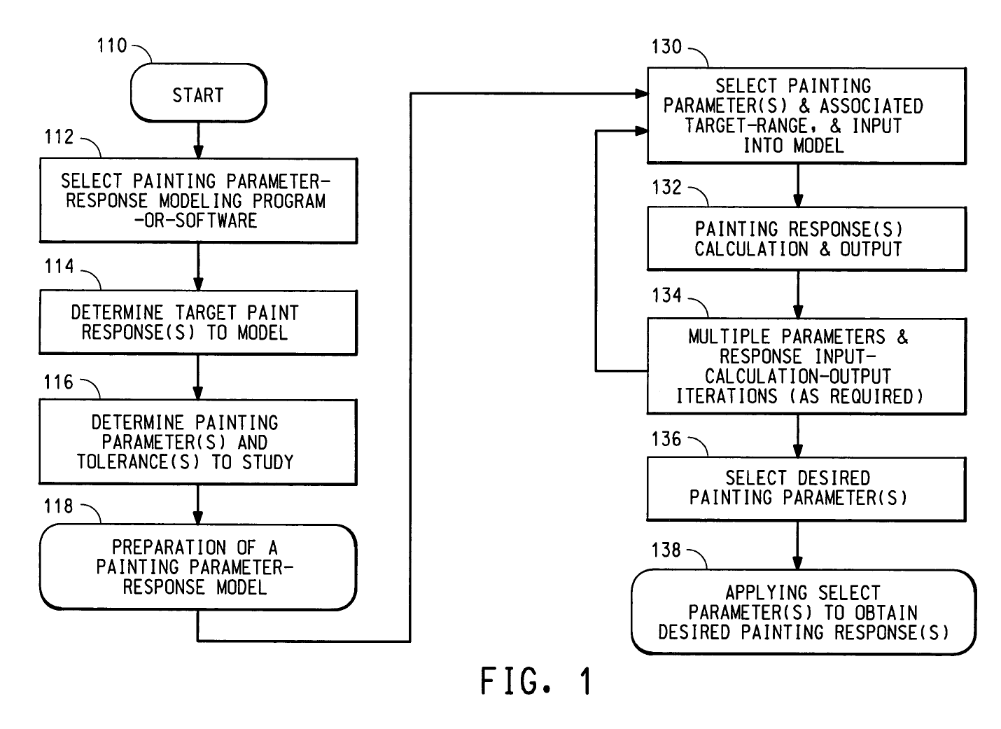

FIG. 1 illustrates the overall steps in an embodiment of the present invention wherein a paint processing parameter prediction tool for paint applicators is developed and utilized. This method may be used as the basis for initial process parameter set points for a new line or new applicator on an existing line. In essence a method based upon the present invention allows the user to calculate process parameters without the need for trial and error experimentation, based upon predetermined painting responses or response tolerances.

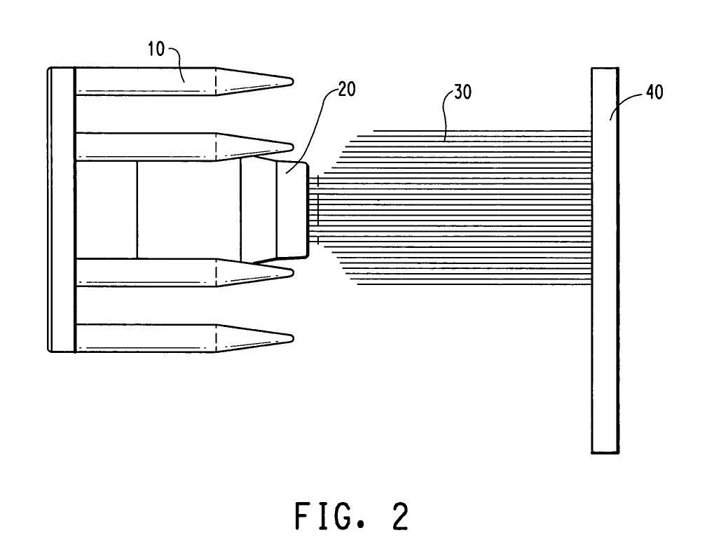

Referring now to FIG. 2, a diagrammatic illustration of a typical rotary-bell paint applicator 20 which supplies a paint spraying jet 30 or a paint spray cloud 30 is shown. The paint is typically charged by electrodes 10. The paint is deposited onto an object 40, which is commonly referred to as a substrate 40.

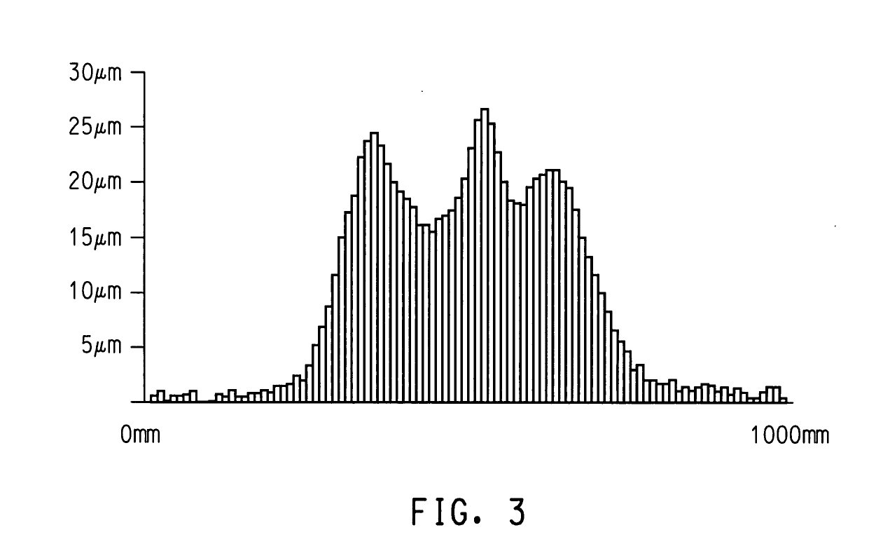

A paint layer can be produced on the substrate 40 of FIG. 2 by a horizontal or vertical movement of the painting applicator 20 and a paint thickness distribution can be measured. FIG. 3, a graphical representation of a real paint thickness distribution as applied by a typical rotary-bell paint applicator, shows the result of such a paint layer analysis in 2-dimensional form, the paint layer thickness in micrometers being specified on the ordinate, and a measured value being specified on the abscissa.

The application of paint onto a substrate by a rotary-bell paint applicator, or any applicator for that matter, is controlled by several parameters. Proper positioning of these parameters results in optimal paint properties or responses. An advantage of the present invention is that the user is provided a means to select parameters which give optimal responses, in an efficient manner without the need to resort to lengthy study in the industrial painting environment.

Referring back to FIG. 1, start block 110 indicates that block 112 is to be executed. At block 112, a software package capable of mathematically building a paint processing parameter-response model is selected. Examples of useful software package are Minitab version 13 or higher, available from Minitab Inc. of State College, Pa., U.S.A., and JMP version 5, available from SAS Institute Inc. JMP Software of Cary, N.C., U.S.A. However, any software package or program capable of mathematically modeling and determining correlation between input(s) and output(s) may be used.

In FIG. 1 at block 114, paint responses to be used to build the painting parameter-response model are determined. The aforementioned paint responses are typical. However, any paint responses readily apparent to those of skill in the art may be used. Correspondingly, at block 116, parameters and tolerances specific to the paint and/or painting equipment studied are determined. Any painting parameters and tolerances responses may be used, including those previously mentioned. By tolerances, it is meant those practical limitations or ranges of such paint's or painting equipment's operating parameters. For example, a rotary-bell applicator bell-cup revolution per minute (rpm) operating parameter has operational tolerances based upon high and low rpm limits.

In one embodiment of the invention, preferred paint responses include film build, spray pattern width, and spray pattern shape. The preferred painting parameters are atomizing air, fan air, paint volume solids, gun head speed, and paint flow rate for a pneumatic spray gun. In another embodiment, preferred paint responses include film build, spray pattern width, and spray pattern shape, while bell speed, shaping air, paint volume solids, applicator speed and paint flow rate are preferred parameters for a rotary-bell applicator.

Referring again to FIG. 1, a model interrelating at least one painting parameter with one or more painting responses via a painting parameter-response algorithm is mathematically prepared, block 118. Any mathematical means of preparing the model may be used. Techniques may vary from individual factor iteration, extrapolation and curve fitting, design of experiment, and statistical analysis means.

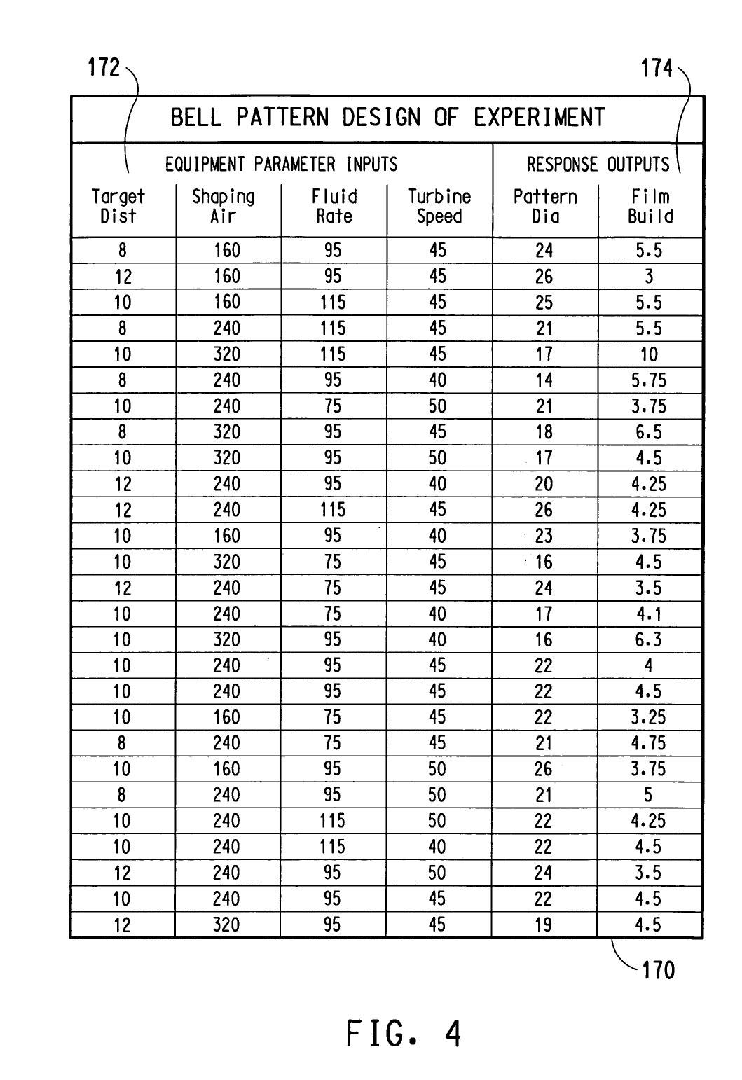

Preferably, design of experiments are employed to determined the interrelationships between painting parameters and painting responses, as shown for example by FIG. 4. This approach produces data upon which mathematical models which depict the interrelationships can be built by statistical analysis and curve fitting techniques. The design of experiment, generally depicted at 170, shows data upon which interrelationship between multiple parameters 172 and responses 174 can be built. Painting parameters 172, in this example, are target distance (inches), bell speed (Krpm), shaping air (SLPM), and bell fluid delivery rates (cc/min.). Example painting responses 174 are film build (microns) and spray pattern diameter (inches).

Referring back to FIG. 1 block 118, in a preferred embodiment, the designed experiments produce painting parameter/response data. Algorithms interrelating parameters and responses through statistical analysis programs, can be used to prepare a painting parameter-response model. Examples of algorithms produced in an embodiment of the invention are given as follows:

$$Painting Response \text{:} Pattern Diameter ( inches ) = ( 31.996 ) + ( 0.447 ) \times \underline{Bell Speed [ rpm ]} - ( 0.149 ) \times \underline{Shaping Air [ slpm ]} + ( 0.0344 ) \times \underline{Fluid rate [ cc per min . ]} + ( 0.00015 ) \times {( \underline{Shaping Air [ slpm ]} )}^{2} - ( 0.000714 ) \times \underline{Bell Speed [ rpm ]} \times \underline{Fluid rate [ cc per min . ]}$$

$$Painting Response \text{:} Film Build ( microns / pass ) = \underline{\% volume solids} / 22 \times ( 11 / \underline{Applicator Speed [ ft per min . ]} ) \times ( ( 9.634 ) - ( 0.139 ) \times \underline{Bell Speed [ rpm ]} + ( 0.0332 ) \times \underline{Shaping Air [ slpm ]} + ( 0.0132 ) \times \underline{Fluid rate [ cc per min . ]} - ( 0.00058 ) \times \underline{Bell Speed [ rpm ]} \times \underline{Shaping Air [ slpm ]} + ( 0.000184 ) \times \underline{Shaping Air [ slpm ]} \times \underline{Fluid rate [ cc per min . ]} )$$

As shown by the above algorithms, a painting response may be a function of any of multiple parameters, such as fan air, atomization air, viscosity, etc. One or more such algorithms may then be used in preparing a painting parameter-response model, which interrelates at least one painting parameter with a painting response, or several responses.

After a painting parameter-response model is prepared, at least one painting parameter and value along with an associated target or target range may then be predetermined and inputted into the model, FIG. 1 block 130. The model then determines and outputs painting response values, or ranges of values, FIG. 1 block 132.

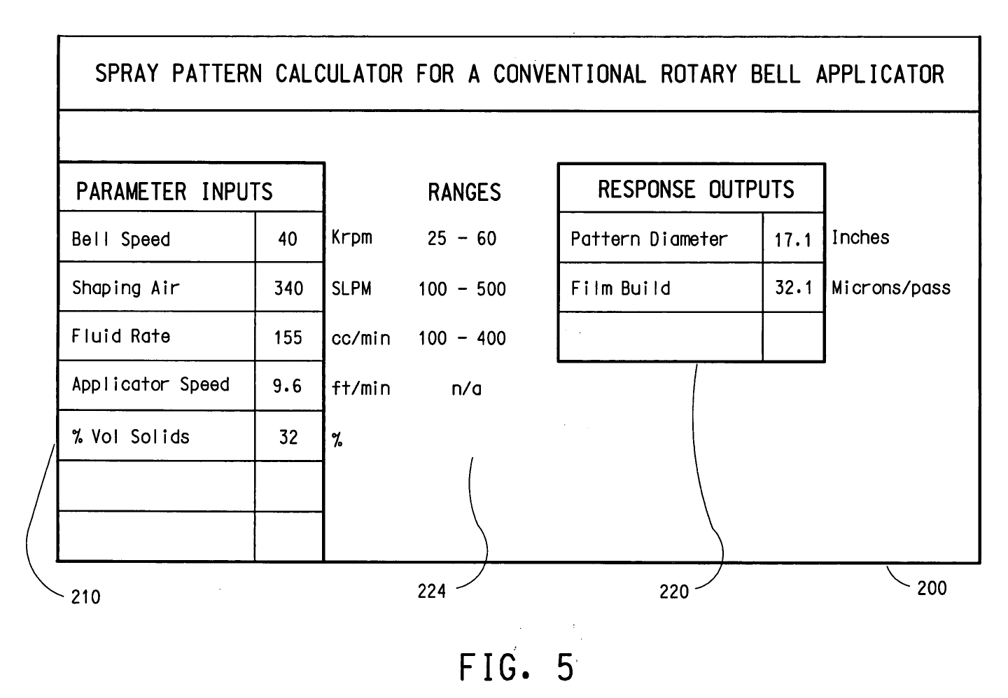

FIG. 5 shows a computer-human input-output scheme, also commonly referred to as a general user interface GUI (generally at 200), preferred for inputting/outputting painting responses and painting parameters. The particular interface shown in FIG. 5 serves as a spray pattern calculator for start-up settings for a conventional rotary bell applicator. The computer-human interface displays parameters 210 and responses 220. The responses 220 are calculated based upon the parameters 210 using a parameter-response model. A user (or a computer program which is coupled to the computer-human interface) can modify the value for each of the parameters 210 in order to determine the modification's effect upon the responses 220.

The computer-human interface as shown in FIG. 5 can be used to modify the painting parameter level so as to achieve a desired level for one or more painting responses. For the preferred embodiment, a simplex mathematical technique is used to assist the user in optimizing the painting response levels along with the painting parameter levels.

Preferably, the computer software used to prepare a computer-human interface, such as that shown in FIG. 5, is based upon Microsoft Windows OS utilizing the Excel software application. These software programs are available from Microsoft Corporation of U.S.A. However, any suitable software program may be used. Any software capable of inputting, calculating, and outputting may be used as well.

The computer-human interface may reside on a computer, separate from or connected with the painting equipment. The invention is not limited to any specific computer-human interface layout, and any practical means of inputting and applying the output using the interface may be used.

The computer-human interface may be embedded into the painting equipment computers, and utilized for equipment startup as well as day to day ongoing equipment adjustments and optimization. For instance, the computer-human interface may be used to calculate and apply painting parameters, based upon targeted painting responses, in an ongoing equipment adjustment and optimization scenario.

Referring back to FIG. 1, at block 134, using the parameter-response model to determine response values based upon the painting parameters, multiple iterations may be made as required. Multiple iterations can be done to generally study the parameter-response trends, or to key in on desired parameter values. The iterations may be made by any practical manual or automatic means.

At FIG. 1 blocks 136 and 138, the user may then select and apply the painting parameters in such way as to obtain the desired painting response or plurality of painting responses. The parameters may be selected and applied by any effective means, manual or automatic.

In an embodiment, the present invention serves as a tool for predicting the size and shape of a spray pattern as well as film build, or even transfer efficiency, as a result of painting process parameters. This tool may be used as the basis for initial process setpoints for a new line or new applicator on an existing line. The tool may also be used for continuous improvement on a day to day basis for existing equipment, facilities, or paint technologies. In essence the tool allows the process engineer to calculate process parameter outputs without doing physical experimentation to determine them, in a wide variety of scenarios.

The present invention may further serve as a tool for comparing paint application equipment. For example, different paint applicator models, different versions or builds of the same applicator model, or different components or versions of the same components of a particular model may be compared using the invention.

According to the present invention, some examples of the paint applicator techniques typically used are conventional techniques such as pneumatic spraying, electrostatic pneumatic spraying, electrostatic rotary bells, and the like. The preferred techniques are air atomized spraying with or without electrostatic enhancement, and high speed rotational electrostatic bells, since these techniques are typically employed in most industrial or automotive paint application processes. However, any readily known paint application technique in the art may be used in conjunction with embodiments of the present invention.

Moreover, it is to be understood that the term painting equipment is not to be limited to only that equipment which sprays the paint, but includes the painting equipment in the plant which also prepares the paint for being fed into the sprayer. Accordingly, the present invention can also establish the settings for such other painting attributes as viscosity of the paint, which is fed into the spray painting equipment. For example, the viscosity painting parameter can be interrelated with such painting responses as sag or pop in the manner discussed above. In this way the material which is eventually fed into the spray painting equipment is prepared based upon the optimal painting parameters and paint responses.

The present invention may be used with any type of paint or coating, and with any applicator, so long as there are measurable responses and parameters. Basecoats, clearcoats, primer coatings, electrocoating, composite systems, tricoats, tinted clearcoats. The invention may be used to predict painting parameters for single coat paints, as well as composite coating systems, such as but not limited to, basecoat-clearcoat, basecoat-midcoat-clearcoat tricoat systems, wet-on-wet primer-basecoat systems, or any other combination readily apparent to those of skill in the art.

The nature of the clearcoat, basecoat, or primer surfacer composition used in conjunction with a coating composition based on the present invention is in no way critical. Any of a wide variety of commercially available industrial clearcoats, basecoat, or primer surfacer compositions may be employed in the present invention, including standard solvent borne, waterborne or powder based systems. High solids solvent borne clearcoats, basecoats, and primer surfacers which have low VOC (volatile organic content) and meet current pollution regulations are more commonly employed. Typically useful solventborne coatings include but are not limited to 2K (two-component) systems of polyol polymers crosslinked with isocyanate and 1K systems of acrylic polyol crosslinked with melamine or 1K acrylosilane systems in combination with polyol and melamine. Epoxy acid systems can also be used. Such finishes provide automobiles and trucks with a mirror-like exterior finish having an attractive aesthetic appearance, including high gloss and DOI (distinctness of image). Suitable 1K solvent borne acrylosilane clearcoat systems that can be used are disclosed in U.S. Pat. No. 5,162,426, hereby incorporated by reference. Suitable 1K solvent borne acrylic/melamine clearcoat systems are disclosed in U.S. Pat. No. 4,591,533, hereby incorporated by reference. Also, 1K waterborne basecoats may be employed, and typically provide the same properties as solventborne basecoats. Any conventional waterborne base coats can be applied. Typically these are aqueous dispersions of an acrylic polymer and an alkylated melamine formaldehyde crosslinking agent. Useful compositions are taught in Nickle and Werner U.S. Pat. No. 5,314,945 issued May 24, 1994, which is hereby incorporated by reference.

The type of computer or device which can be used in embodiments of the present invention is not particularly restricted but may for example be a personal computer. Any computer or device capable of carrying out calculations according to the invention may be used,

Although the invention is illustrated and described herein as embodied in a method for determining and applying painting parameters, it is nevertheless not intended to be limited to the details shown. Various other modifications, alterations, additions or substitutions of the component of the compositions of this invention will be apparent to those skilled in the art without departing from the spirit and scope of this invention. This invention is not limited by the illustrative embodiments set forth herein, but rather is defined by the following claims.

1. A method for predicting and applying painting parameters so that predetermined painting responses are produced, said method comprising:
a. preparing a painting parameter-response model, said model interrelating at least one painting parameter with at least one painting response via a painting parameter-response algorithm;
b. predetermining at least one painting parameter to input into said parameter-response algorithm of said model;
c. determining at least one target painting response based upon said parameter-response algorithm of said model and upon said parameter or plurality of parameters; and
d. applying any said parameter or plurality of parameters to the painting equipment in such way as to obtain said painting response or plurality of painting responses.

2. A method for predicting and applying painting parameters so that predetermined painting responses are produced, said method comprising:
a. preparing a painting parameter-response model, said model interrelating at least one painting parameter with at least one painting response via a painting parameter-response algorithm;
b. predetermining at least one target painting response to input into said parameter-response algorithm of said model;
c. determining at least one painting parameter based upon said parameter-response algorithm of said model and upon said response or plurality of responses; and
d. applying any said parameter or plurality of parameters to the painting equipment in such way as to obtain said painting response or plurality of painting responses.

3. The method of claim 1 or 2 wherein said painting parameter-response model is based upon a design of experiments interrelating said painting parameters with said painting response.

4. The method of claim 1 or 2 wherein said painting parameter-response model includes interrelating a plurality of painting parameters with a plurality of painting responses.

5. The method of claim 1 or 2 which includes a computer-human interface for inputting said painting response, inputting permissible level ranges for said painting parameters, and determining painting parameters.

6. The method of claim 1 or 2 wherein said plurality of paint responses comprise spray pattern diameter and average spray pattern film build

7. The method of claim 6 which further comprises spray pattern shape as a paint response.

8. The method of claim 7 which further comprises transfer efficiency as a paint response.

9. The use of the method of claim 1 to determine painting parameters.

10. The use of the method of claim 1 to determine initial setpoints for painting parameters.

11. The use of the method of claim 1 to compare paint application equipment or equipment components.
